(19) United States
(12) Patent Application Publication
(10) Pub. No.: US 2005/0203758 A1
(43) Pub. Date: Sep. 15, 2005

(54) Method for remote evaluation and management of vehicular parts

(76) Inventors: Wilfried Blum, Stouffville (CA); Stephen Noel, Saint-Lazare (CA); Albert R. Carbone, Saint-Lambert (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/798,311

(22) Filed: Mar. 12, 2004

(51) Int. Cl. G06F 17/60

(52) U.S. Cl. 705/1

(57) ABSTRACT

A computer-based method for vehicular part remote evaluation and management is presented. The method comprises obtaining from a first location description information regarding a state of a vehicular part. The description information is transmitted to a second location. The description information is analyzed in order to provide an assessment of the state of the vehicular part and the assessment information is transmitted back to the first location, allowing informed decisions to be made as to the disposition of the vehicular part.

### FIELD OF THE INVENTION

The invention relates to a method for remotely evaluating and managing vehicular parts. More specifically, it relates to a method allowing for remote analysis and assessment of a vehicular part in order to determine a disposition thereof.

### BACKGROUND OF THE INVENTION

Currently, vehicular part management involves various steps which are error-prone, time-consuming and costly for all parties involved. At a car dealership for example, when handling vehicular parts that are either inoperative or worn, the dealer must have a means to assess the quality of each part in order to discard it or recycle it. When concluding that a certain vehicular part has potential to be rebuilt or re-manufactured, the dealer sends it to the Original Equipment Manufacturer (OEM) and/or a third party remanufacturer. In doing so however, there exists the risk that the OEM and/or third party remanufacturer might assess that the part received does not qualify for being rebuilt or re-manufactured, since its quality is below certain standards. In such a case, shipping, processing and storage costs were wasted on a scrap part. The problem is that the condition of the vehicular part is not accurately evaluated before being sent to the next step in the recycling process. Currently, there exists no system that allows reducing processing costs by evaluating and grading parts before they leave the dealership.

Another problem can arise once the OEM and/or third party remanufacturer receives a vehicular part and the part is subjected to inspection and part identification so that the subsystems and components can be cleaned, tested, repaired or replaced. During this process, it may be discovered that the part is missing subsystems or components which may be either difficult or time-consuming to acquire, or worse, the part may be missing a critical ‘matched’ component which simply cannot be replaced. An example of would be a casting which is split during the original manufacturing process to create two matched pieces; if one of these pieces is lost, it cannot be simply replaced with another stock part, so the entire assembly is now useless. Significant cost saving can be attained by detecting such missing components and allowing the dealership to find these components before shipping the part. Currently, there exists no system that allows the detection of missing components from parts before they leave the dealership.

### SUMMARY OF THE INVENTION

Accordingly, an object of the present invention is to provide a method for remotely evaluating and managing used vehicular parts and warranty return parts which is error-proof, time-saving and cost efficient for all parties involved.

According to a first broad aspect of the invention, there is provided a method for vehicular part evaluation comprising: obtaining from a first location description information regarding a state of a vehicular part; sending the description information to a second location; and receiving from the second location an assessment based on the description information.

According to a second broad aspect of the invention, there is provided a method for vehicular part life cycle management comprising: providing at a first location identification information for the first location, providing description information regarding a state of a vehicular part from an inventory at the first location, sending the identification information and the description information to a second location, analyzing the description information in order to provide an assessment of the state of the vehicular part, using the identification information to send the assessment of the vehicular part to the first location, receiving the assessment at the first location and determining a disposition for the vehicular part based on the assessment.

According to a third broad aspect of the invention, there is provided a data center used in the remote evaluation of a vehicular part. The data center comprises a computer server adapted to communicate with a first location and a second location. The computer server comprises input means for receiving, from the first location, description information regarding a state of the vehicular part. The computer server also comprises output means for sending the description information to the second location. The input means is also for receiving, from the second location, an assessment based on the description information. The data center may also include a server database for storing an electronic folder comprising the description information.

An exemplary advantage of the foregoing method is that if the list of missing components is determined before a part is shipped, critical missing parts could be identified and located, and orders could be placed for replacement components early on and thus reduce costs.

### BRIEF DESCRIPTION OF THE DRAWINGS

These and other features, aspects and advantages of the present invention will become better understood with regard to the following description and accompanying drawings wherein:

FIG. 1 is a block diagram of the system configuration for a preferred embodiment of the invention;

FIG. 2 is a flow chart of a method for managing the life cycle of vehicular parts according to a preferred embodiment of the invention;

### DETAILED DESCRIPTION OF THE INVENTION

A preferred embodiment of the present invention will now be described in detail.

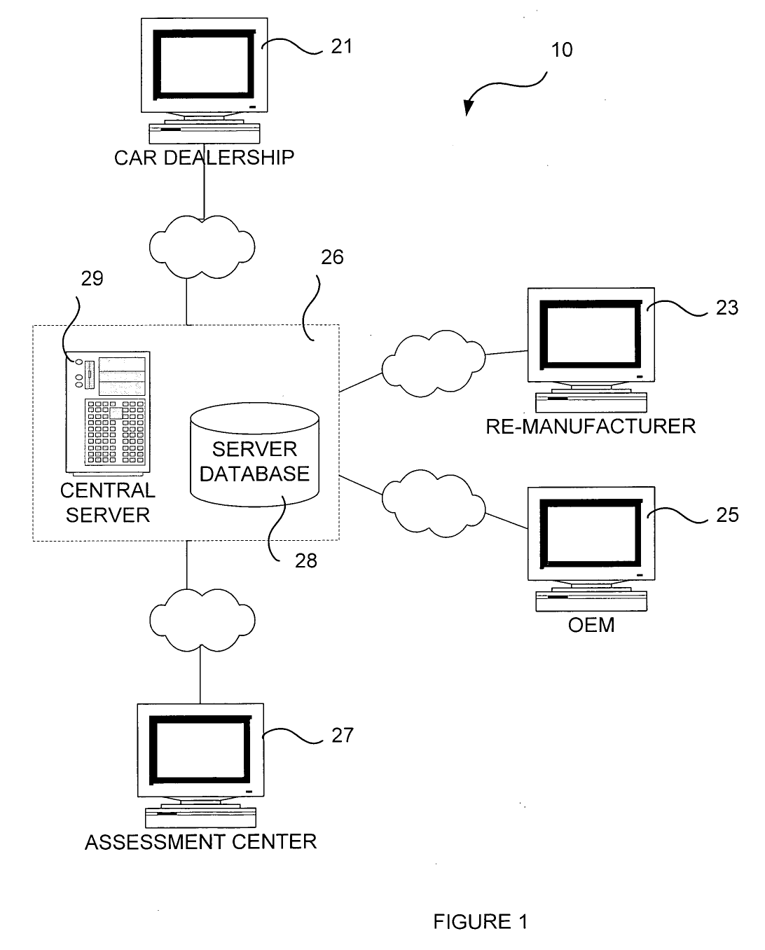

Referring to FIG. 1, the preferred embodiment of the system 10 contains two computer-based stations 21, 27 communicating with each other through a central server 29. In this embodiment, for exemplary purposes, only one dealership station 21 and one assessment center 27 are shown, although a plurality of dealership stations 21 could communicate with a plurality of assessment centers 27 as part of the same system 10. The stations 21, 27 communicate via any suitable transmission media, such as an ordinary public telephone line, a data quality line, a radio link or any other transmission media suitable for inter-computer communication.

In a preferred embodiment, the car dealership station 21 is a computer platform running, for example, client software or a web-based application, and is in connection with a data center 26. The station 21 allows a user at the car dealership to create a new record for a core that is to be assessed. A core may be a used vehicular part or warranty return part. In the preferred embodiment, a core is understood to be a non-functioning vehicular part which can be remanufactured.

At the car dealership, the computer platform comprises a computer system and means for image acquisition. An exemplary computer system may comprise: a computer, an input system including a keyboard and a mouse, a display device, a digital camera, a document scanning device, a communication control device for communication with the network and possibly an external storage device. The computer includes a central processor unit (CPU), a read only memory (ROM), a random access memory (RAM) and an internal storage device. The software running at the car dealership may reside on an external storage device or an internal one.

The station 21 provides means for recording information data, such as textual and numerical data, as well as digital imaging data, scanned documents, recorded audio and video data, etc., related to a vehicular part or core. In a preferred embodiment of the present invention, a user interacts with the station 21 through a graphical user interface (GUI). The GUI provides access to the inventory of vehicular parts as stored in a database at the car dealership station 21.

In an exemplary embodiment of the invention, the car dealership 21 may be more generally referred to as a first location and comprises an authorized representative of an original equipment manufacturer.

In an exemplary embodiment of the invention, the assessment center 27 may be more generally referred to as a second location and may also comprise at least one of an original equipment manufacturer, an independent assessing center, and a warranty processing center.

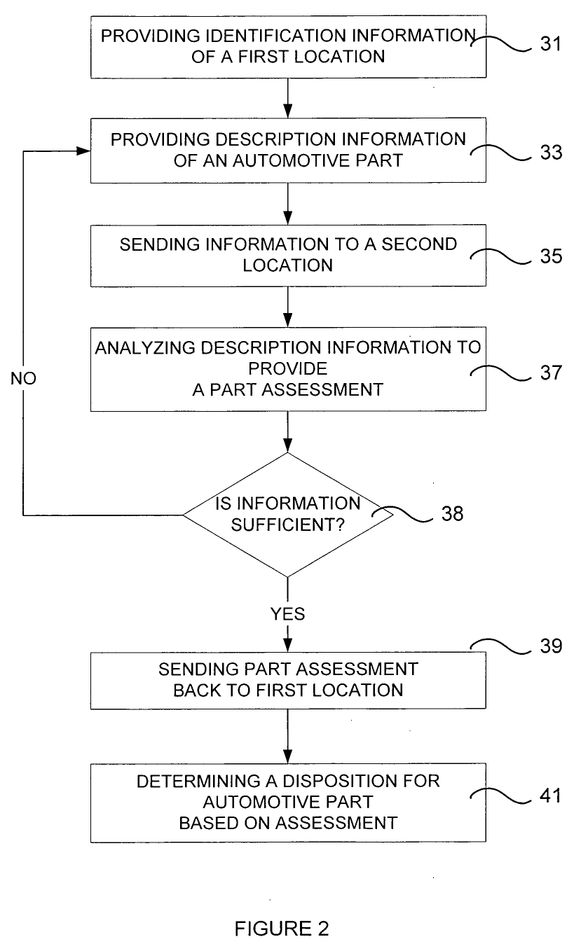

Now, in reference to FIG. 2, a method for managing a vehicular part will be described. Upon receiving a vehicular part, a user at the car dealership creates a new electronic folder containing information regarding this vehicular part. As per step 31, the electronic folder contains identification information for the car dealership, such as a dealership id number, name, address, phone number, etc. The electronic folder may also contain identification information for the OEM of the respective core. In the newly created electronic folder, the user specifies the action to be executed by the system 10, for example, that the vehicular part information should be submitted for assessment.

According to step 33, the user first proceeds by entering core information data into the system. The GUI provides drop-down menus and text fields for assisting the user in inputting the core information data. The core information to be provided includes a core tag number, an OEM identification such as the OEM abbreviation, a core P/N, a brief core description, a mileage figure, a Vehicle Identification Number (VIN), a core S/N, a date of installation, a failure mode of the core, etc. The GUI also provides a free text box area allowing the user to provide additional comments regarding the core to be assessed. The electronic folder also provides a grade field, which can be filled in at the assessment center with a respective grade for the core, following its evaluation.

The system facilitates the task of the car dealership as it only requires that the user at the car dealership provides general information regarding the core, without any in-depth inspection.

The user also has the ability of importing additional descriptive information such as digital images, scanned documents, and recorded audio and video data, into the system that may be attached to the electronic folder. The information in the electronic folder thereby allows the assessment center to perform an off-site visual inspection of the core to be graded. The additional descriptive information available in the system may be referenced for inspection at all times. Each additional stored descriptive information item may contain information including the capture date and extra notes describing the information contained within the item or a particular problem of interest. Annotation features allow for elements such as small arrows, pointers, and highlights to be overlaid on digital images and scanned documents to call attention to specific details.

All electronic folders stored in the car dealership system database may be accessed by the user by consulting the part management list. The part management list displays information about the folders such as an audit trail section, detailing the assessment process exchanges of information between the car dealership and the assessment center. The management system provides edit locking feature which prevents multiple parties from accidentally making simultaneous changes to the electronic folder.

For each electronic folder entry, key information from the electronic folder contents is displayed, as well as information pertaining to the status of the core: the status may be one of “assessment requested”, “additional information requested”, “shipped”, “scrapped”, etc. The core status is updated with each transmission of the electronic folder. For each entry there is provided an event-driven status indicator, tracking the progress of the core claim. The system also displays a visual indicator of the transmission status of a particular electronic folder. When items are selected to be transmitted, they are placed in an “outbox” or a transmission queue. The display on the screen shows the number of items in the transmission queue, the ones completed and the ones suspended.

When an electronic folder is ready for transmission as per step 35, it contains the identification information of a destination. In a preferred embodiment of the present invention, the destination is an assessment center. Upon being transmitted, the electronic folder is routed to a central server. At the central server, the contents of the electronic folder are analyzed in order to determine its destination.

In order to optimize the processing of electronic folders, each individual folder can be routed based on its contents. For example, in an embodiment of the present invention, different assessment centers may be set up, each having different parts specializations. An assessment center may for example be experienced with engine cores, another assessment center with cylinder heads, while another with electronic assemblies. Based on the type of part described in the electronic folder, the server can automatically route the folder to the appropriate assessment center.

In another embodiment of the present invention, in the case in which the cores are returned warranty parts, the electronic folder can automatically be routed to the OEM, without the need for the car dealership to specify a destination. The server 29 stores such rules for routing return warranty parts to their respective OEMs, as well as other destination rules. Since destination rules are managed at the server 29 level, changes to the rules could be made globally without requiring any modification of the car dealership system 21 setup.

Once the destination is identified, the server 29 routes the incoming electronic folder to the particular destination address.

At the same time, the server 29 stores a copy of the electronic folder in a server database 28, which is preferably part of the data center 26. The fact that the information is stored in the server database 28 allows for third parties to access the status of a given electronic folder by using a web browser. Such third parties include re-manufacturers and OEMs.

A user at a third location may access the system by using any commercially available Internet web browser to address the particular website. Any remote terminal with web-browsing abilities, such as a personal computer, a web-enhanced cellular phone or a personal digital assistant may be used. Upon requesting the address corresponding to the particular website, a home page is loaded in the browser, requesting the users identification credentials (typically a username and password). Access to the server 29 contents can be controlled using a variety of security mechanisms, including 128-bit SSL encryption. The user will provide their credentials and will send the data to the server, by clicking on a ‘submit’-type button. An authentication process takes place on the server side, during which the supplied credentials are checked against a list of authorized users. If the provided credentials result in an exact match, another page is loaded into the user's browser. This page contains information about the current status of certain electronic folders. Since all electronic folders pass through the server 29, the complete history and exact location of each electronic folder are readily available. The specific information the user has access to, as well as the format in which it is presented, is in accordance with the user's individual profile.

The server 29 also performs validation of incoming electronic folders. The electronic folders are scanned for missing or incomplete data in order to ensure that proper data entry is being performed by all parties. The set of rules used for this type of validation are stored on the central server 29 and could be customized to the needs of each subscribing OEM.

The data stored in the server database 28 can also be used for data mining or report generation. The data and reports may be provided in a format which is compatible with the internal data management systems of the interested party.

The assessment center system 27 and client software is very similar to that described for the car dealership 21. In the preferred embodiment of the present invention, the assessment center 27 is provided by an independent agency. In alternative embodiments, the assessment center may be affiliated with the OEM or with a re-manufacturer.

As per step 37, an assessor at the assessment center determines the quality of the core using all of the core information data and additional descriptive information supplied through the electronic folder. If the electronic folder contains sufficient information in order to assess the core (at step 38), then as per step 39, the folder is then returned to the dealer along with the assessment or grading and a list of missing parts. If the assessor cannot accurately determine the quality of the core (at step 38), the assessor can request additional information from the car dealership 21 by returning the electronic core folder with comments or questions. The dealer will add the missing information and return the electronic folder to the assessor. The process can loop through steps 33, 35 and 37 until the assessor is satisfied that the supplied information is sufficient to permit an accurate grading of the quality of the core.

Once the core is assigned a grading and in accordance to step 41, the dealer determines a disposition for the vehicular part based on said assessment. The dealer may either discard the core (if it has been determined to be unrebuildable) or ship it directly to the OEM-specified remanufacturer. The dealer may send the core to be repaired and/or recycled. The dealership system 21 can print the shipping label for the package, which clearly identifies the destination address, part number, the assessed grading, and any other textual or bar-coded information required for efficient processing at the receiving end.

When the dealer ships the core and closes the electronic folder, a notification of this transaction is automatically transmitted to the OEM. This notification confirms that the dealer has shipped a rebuildable core to the remanufacturer and can be credited. The notification method can range from simple email to a more tightly integrated electronic business-to-business solution.

When the core is received by the remanufacturer, the core can be moved directly into stores without requiring further inspection. The cores can be sorted and stored according to their assigned grading, allowing the remanufacturer to selectively rebuild the best quality cores first. The grading of each core can be easily identified either by reading the printed identification label or by looking up the core identification number on the website, which displays the electronic folder for each assessed part, including the grading, list of missing parts, and original images.

In an alternative embodiment of the present invention, the second location may be a warranty processing center and the contents of the electronic folder may relate to a part described in a warranty claim.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

1. A method for remotely evaluating a vehicular part, said method comprising:
obtaining, from a first location, description information regarding a state of said vehicular part;
sending said description information to a second location; and
receiving, from said second location, an assessment based on said description information.

2. A method as claimed in claim 1, wherein said description information comprises at least one of textual data, numerical data, binary data, scanned documents, digital images, digital audio and video of said vehicular part.

3. A method as claimed in claim 2, wherein said description information is comprised in an electronic folder created at said first location, and said electronic folder is modified at said second location to include said assessment.

4. A method as claimed in claim 2, further comprising at least one of mining data and generating reports for a plurality of vehicular parts and their assessment.

5. A method as claimed in claim 4, wherein said data and reports are compatible with internal data management systems of a party receiving said data and reports.

6. A method as claimed in claim 1, further comprising determining at least one of a disposition and a warranty settlement for said vehicular part based on said assessment.

7. A method as claimed in claim 6, wherein said description information comprises at least one of textual data, numerical data, binary data, scanned documents, digital images, digital audio and video of said vehicular part.

8. A method as claimed in claim 7, wherein said description information is comprised in an electronic folder at said first location, and said electronic folder is modified at said second location to include said assessment.

9. A method as claimed in claim 7, further comprising at least one of mining data and generating reports for a plurality of vehicular parts and their assessment.

10. A method as claimed in claim 9, wherein said data and reports are compatible with internal data management systems of a party receiving said data and reports.

11. A method as claimed in claim 6, further comprising the step of sending said vehicular part to a third party for at least one of repair and recycling.

12. A method as claimed in claim 11, further comprising at least one of identifying and ordering missing materials required for remanufacturing of said vehicular part based on said assessment details.

13. A method as claimed in claim 12, further comprising the automated ordering of said materials required for remanufacturing of said vehicular part.

14. A method as claimed in claim 1, wherein said first location comprises an authorized representative of an original equipment manufacturer.

15. A method as claimed in claim 1, wherein said second location comprises at least one of an independent assessing center, an original equipment manufacturer, and a warranty processing center.

16. A method as claimed in claim 1, further comprising the step of providing access to a party at a third location to said assessment details.

17. A method as claimed in claim 16, wherein said party at said third location accesses said assessment details through an Internet web browser.

18. A method as claimed in claim 16, wherein said party at said third location comprises an original equipment manufacturer.

19. A method as claimed in claim 18, further comprising the step of producing data and reports for a plurality of vehicular parts and their assessment.

20. A method as claimed in claim 19, further comprising the step of providing said data and reports in such as format as to be compatible with internal data management systems of a party receiving said data and reports.

21. A method for management of a vehicular part comprising:
providing, at a first location, identification information for said first location;
providing description information regarding a state of said vehicular part at said first location;
sending said identification information and said description information to a second location;
analyzing said description information in order to provide an assessment of said state of said vehicular part;
using said identification information to send said assessment of said vehicular part to said first location;
receiving said assessment at said first location and determining at least one of a disposition and a warranty settlement for said vehicular part based on said assessment.

22. A method as claimed in claim 21, wherein said description information comprises at least one of textual data, numerical data, binary data, scanned documents, digital images, digital audio and video of said vehicular part.

23. A method as claimed in claim 22, wherein said description information is comprised in an electronic folder created at said first location, and said electronic folder is modified at said second location to include said assessment.

24. A method as claimed in claim 22, further comprising at least one of mining data and generating reports for a plurality of vehicular parts and their assessment.

25. A method as claimed in claim 24, wherein said data and reports are compatible with internal data management systems of a party receiving said data and reports.

26. A method as claimed in claim 21, further comprising at least one of identifying and ordering missing materials required for remanufacturing of said vehicular part based on said assessment details.

27. A method as claimed in claim 26, further comprising the automated ordering of said materials required for remanufacturing of said vehicular part.

28. A data center used in the remote evaluation of a vehicular part, said data center comprising:
a computer server adapted to communicate with a first location and a second location, said computer server comprising:
input means for receiving, from said first location, description information regarding a state of said vehicular part;
output means for sending said description information to said second location; and
said input means for further receiving, from said second location, an assessment based on said description information.

29. A data center as claimed in claim 28, wherein said description information comprises at least one of textual data, numerical data, binary data, scanned documents, digital images, digital audio and video of said vehicular part.

30. A data center as claimed in claim 29, wherein said description information is comprised in an electronic folder created at said first location, and said electronic folder is modified at said second location to include said assessment.

31. A data center as claimed in claim 30, further comprising a server database for storing at least a portion of said description information in said electronic folder.

32. A data center as claimed in claim 28, wherein said computer server is further adapted to communicate with a third location and said output means further sends said assessment to said third location.

33. A data center as claimed in claim 28, wherein said computer server is adapted to determine at least one of a disposition and a warranty settlement for said vehicular part based on said assessment.

34. A data center as claimed in claim 33, wherein said description information comprises at least one of textual data, numerical data, binary data, scanned documents, digital images, digital audio and video of said vehicular part.

35. A data center as claimed in claim 34, wherein said description information is comprised in an electronic folder at said first location, and said electronic folder is modified at said second location to include said assessment.

36. A data center as claimed in claim 35, further comprising a server database for storing at least a portion of said description information in said electronic folder.

37. A data center as claimed in claim 33, wherein said computer server is further adapted to communicate with a third location and said output means further sends said assessment to said third location.
